(19) United States
(12) Patent Application Publication
(10) Pub. No.: US 2011/0189063 A1
(43) Pub. Date: Aug. 4, 2011

(54) IMMUNOCHROMATOGRAPHIC TEST PIECE, IMMUNOCHROMATOGRAPHIC TEST PIECE SET, IMMUNOCHROMATOGRAPHIC SYSTEM, AND IMMUNOCHROMATOGRAPHIC DEVICE

(75) Inventors: Masayoshi MOMIYAMA, Handa-shi (JP); Atsushi Hattori, Nagoya-shi (JP); Masayuki Ito, Ann Arbor, MI (US)

(73) Assignee: AISIN SEIKI KABUSHIKI KAISHA, Kariya-shi (JP)

(21) Appl. No.: 13/010,175

(22) Filed: Jan. 20, 2011

(30) Foreign Application Priority Data
Jan. 29, 2010 (JP) 2010-018279

(51) Int. Cl. B01J 19/00

(52) U.S. Cl. 422/401

(57) ABSTRACT

An immunochromatographic test piece measuring a concentration of a measurement object included in a solution includes a carrier causing the solution that includes the measurement object to flow from an upstream to a downstream of the carrier, and a plurality of color regions arranged at the carrier in series in a flow direction in which the solution flows through the carrier and spaced away from one another in the flow direction. The plurality of color regions each includes a capture reagent and is colored while capturing the measurement object included in the solution by the capture reagent. The plurality of color regions is formed at respective portions of the carrier, the respective portions having same dimensions and including same concentrations of the capture reagent per unit area.

### CROSS REFERENCE TO RELATED APPLICATIONS

This application is based on and claims priority under 35 U.S.C. §119 to Japanese Patent Application 2010-018279, filed on Jan. 29, 2010, the entire content of which is incorporated herein by reference.

### TECHNICAL FIELD

This disclosure relates to an immunochromatographic test piece, an immunochromatographic test piece set, an immunochromatographic system, and an immunochromatographic device.

### BACKGROUND DISCUSSION

Known immunochromatographic test pieces for a measurement of a concentration of a measurement object included in a test solution are disclosed in JP3005303B, JPH07-325085A, and JP2009-267952A. Each of the disclosed immunochromatographic test pieces includes a carrier formed by paper, or the like having hydrophilicity so that the test solution including the measurement object flows from an upstream to a downstream of the carrier. The carrier includes a single first color region that contains a first capture reagent and that is colored when the measurement object contained in the test solution is captured by the first capture reagent, and a single second color region provided at the downstream of the carrier relative to the first color region in a flow direction of the test solution. The second color region includes a second capture reagent for capturing the measurement object contained in the test solution that has passed through the first color region. The second color region is colored when the measurement object is captured by the second capture reagent. According to each of the aforementioned immunochromatographic test pieces, the concentration of the measurement object contained in the test solution is measurable on a basis of a comparison of intensity of color development between the single first color region and the single second color region.

According to the immunochromatographic test piece disclosed in JP3005303B, multiple first color regions may be arranged at the carrier in series in the flow direction. In this case, the concentration of the first capture reagent contained in the multiple first color regions is specified so that the concentration is higher in the first color region at the downstream of the carrier and is lower in the first color region at the upstream of the carrier. That is, the concentration of the first capture reagent is gradually increasing towards the downstream from the upstream of the carrier (i.e., gradient of concentration).

According to each of the disclosed immunochromatographic test pieces, the concentration of the measurement object contained in the test solution is measurable on a basis of a difference between the intensity of color development of the single first color region and the intensity of color development of the single second color region. However, a further improvement of a measurement accuracy is required in a test and measurement industry for a visual measurement or observation. Further, even when the measurement of the concentration of the measurement object contained in the test solution is achieved by means of a measurement device such as an image sensor, the approximate measurement in advance by visual observation relative to the concentration of the measurement object contained in the test solution may assist a selection of a calibration curve, and the like for the measurement by the measurement device.

A need thus exists for an immunochromatographic test piece, an immunochromatographic test piece set, an immunochromatographic system, and an immunochromatographic device which are not susceptible to the drawback mentioned above.

### SUMMARY

According to an aspect of this disclosure, an immunochromatographic test piece measuring a concentration of a measurement object included in a solution includes a carrier causing the solution that includes the measurement object to flow from an upstream to a downstream of the carrier, and a plurality of color regions arranged at the carrier in series in a flow direction in which the solution flows through the carrier and spaced away from one another in the flow direction. The plurality of color regions each includes a capture reagent and is colored white capturing the measurement object included in the solution by the capture reagent. The plurality of color regions is formed at respective portions of the carrier, the respective portions having same dimensions and including same concentrations of the capture reagent per unit area.

According to another aspect of this disclosure, an immunochromatographic test piece measuring a concentration of a measurement object included in a solution includes a carrier causing the solution that includes the measurement object to flow from an upstream to a downstream of the carrier, a plurality of first color regions arranged at the carrier in series in a flow direction in which the solution flows through the carrier and spaced away from one another in the flow direction, the plurality of first color regions each including a first capture reagent and being colored while capturing the measurement object included in the solution by the first capture reagent, and a second color region arranged at the downstream of the carrier in the flow direction relative to the plurality of first color regions and including a second capture reagent capturing the measurement object included in the solution that has passed through the plurality of first color regions, the second color region being colored while capturing the measurement object by the second capture reagent. The plurality of first color regions is formed at respective portions of the carrier, the respective portions having same dimensions and including same concentrations of the first capture reagent per unit area.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view illustrating a test piece in which a first capture reagent is contained in first color regions according to a first embodiment disclosed here;

FIG. 2 is a schematic view illustrating the test piece in which antibodies are captured by the first capture reagent in the first color regions according to the first embodiment;

FIG. 3 is a schematic view illustrating the test piece in which complexes including the antibodies and antigens are captured by a second capture reagent in a second color region according to the first embodiment;

FIG. 4 is a plan view schematically illustrating a device accommodating the test piece according to the first embodiment;

FIG. 5 is a diagram illustrating a test result of color development state of the test piece according to the first embodiment;

FIG. 6 is a diagram illustrating a test result obtained by a comparison example manufactured basically in the same condition as the first embodiment;

FIG. 7 is a diagram illustrating a relationship among a concentration of the antigens, a flow speed of a test solution, and the color development state according to a second embodiment;

FIG. 8 is a diagram illustrating a relationship among the concentration of the antigens, the flow speed of the test solution, and the color development state according to a third embodiment;

FIG. 9 is a cross-sectional view schematically illustrating a state where the test piece is placed on a holding portion having a temperature adjusting function according to a fourth embodiment;

FIG. 10 is a diagram illustrating a relationship among a test temperature, a development time, the concentration of the antigens, and the color development state according to the fourth embodiment;

FIG. 11 is a diagram illustrating a relationship among a content percentage of a hydrophilic surfactant in volume, the concentration of the antigens, and the color development state according to a fifth embodiment;

FIG. 12 is a plan view illustrating the test piece according to a sixth embodiment;

FIG. 13 is a side view schematically illustrating the device accommodating the test piece according to a seventh embodiment; and

FIG. 14 is a schematic view illustrating the test piece in which a capture reagent is contained in multiple color regions according to an eighth embodiment.

### DETAILED DESCRIPTION

### First Embodiment

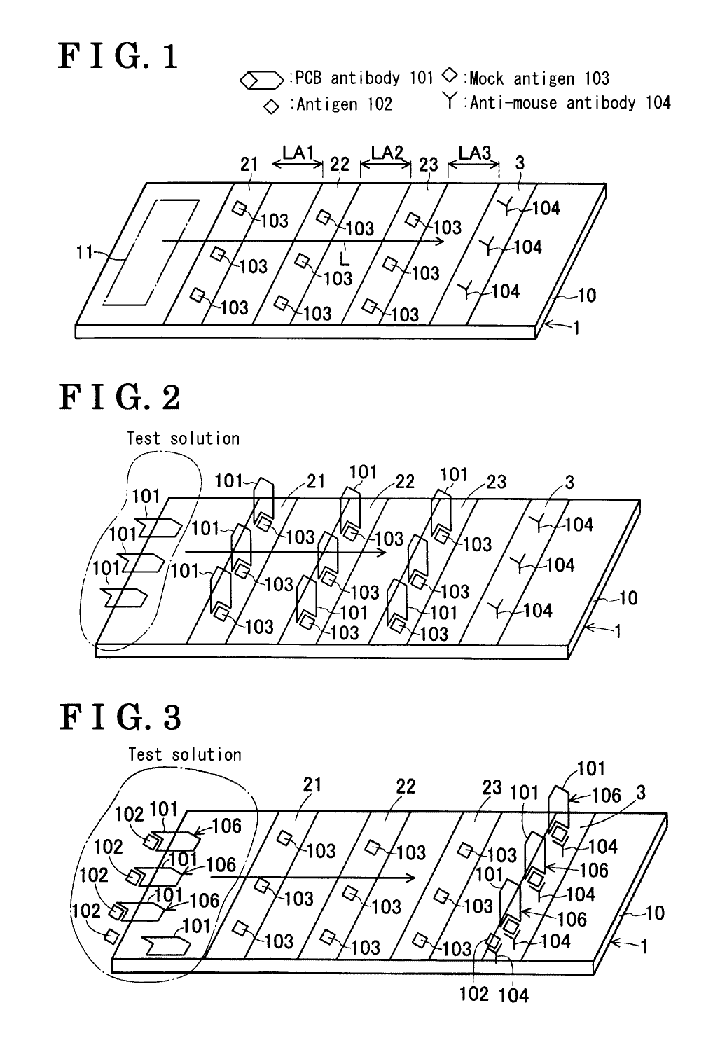

A basic principle of immunochromatography will be explained on a basis of an antigen-antibody reaction with reference to FIGS. 1 to 3. A carrier 10 constituting a test piece 1 serving as an immunochromatographic test piece according to a first embodiment has an even thickness over an entire length thereof and has hydrophilicity to thereby cause a test solution serving as a solution to flow from an upstream to a downstream of the carrier 10 along a flow direction (i.e., a direction of an arrow L in FIG. 1). The carrier 10 may be porous so that a capillarity phenomenon is applied. Accordingly, the carrier 10 is formed, for example, by paper that is a fiber assembly in which fibers are tangled. The fibers include organic fibers such as cellulose fibers, glass fibers, and the like. Alternatively, a cellulose membrane, a nitrocellulose membrane, a nylon membrane, or the like is used as the carrier 10.

First color regions 21, 22, and 23 are arranged at the carrier 10 in series in the flow direction in which the test solution flows through the carrier 10 (as indicated by the arrow L) and are spaced away from one another in the flow direction. Each of the first color regions 21, 22, and 23 is formed into a strip shape while extending in a direction perpendicular to the direction of the arrow L. Distances among the first color regions 21, 22, 23, and a second color region 3, i.e., pitches LA1, LA2, and LA3, are the same as one another as illustrated in FIGS. 1 to 3, but may be different. Each of the first color regions 21, 22, and 23 formed at the carrier 10 includes mock antigens 103, serving as a first capture reagent, obtained by PCB (polychlorinated biphenyl) binding to serum albumin, for example.

According to the first embodiment, the multiple first color regions 21, 22, and 23 arranged in series in the flow direction are formed at respective portions of the carrier 10, the respective portions having the same dimensions and including the same concentrations of the mock antigens 103 per unit area. Specifically, a highest concentration of the mock antigens 103 per unit area among the first color regions 21, 22, and 23 is defined to be Cmax while a lowest concentration of the mock antigens 103 per unit area among the first color regions 21, 22, and 23 is defined to be Cmin. A value of Cmax/Cmin may fall within a range from 0.85 to 1.15, a range from 0.90 to 1.10, or a range from 0.95 to 1.05. More specifically, the value of Cmax/Cmin may fall within a range from 0.98 to 1.02 or may be equal to 1.0. The aforementioned concentration of the mock antigens 103 corresponds to a volume of carrier of the first capture reagent. A reagent solution including the mock antigens 103 as the first capture reagent in the uniform concentration is applied to the carrier 10, or the carrier 10 is immersed with the reagent solution so as to form the first color regions 21, 22, and 23 at the carrier 10.

The second color region 3 is positioned at the downstream of the carrier 10 in the flow direction (the direction of the arrow L) relative to the first color regions 21, 22, and 23. The second color region 3 includes anti-mouse antibodies 104 that serve as a second capture reagent and that specifically bind to antigens 102 serving as a measurement object. FIG. 2 illustrates a case where the test solution does no substantially include the antigens 102 that are the measurement object but includes antibodies 101.

In FIG. 2, when the test solution flows through the carrier 10 to reach the first color regions 21, 22, and 23, the antibodies 101 contained in the test solution specifically bind to the mock antigens 103 serving as the first capture reagent and contained in the first color regions 21, 22, and 23. Then, the antibodies 101 are captured at the first color regions 21, 22, and 23. At this time, because of a dye binding to the antibodies 101, the first color regions 21, 22, and 23, where the antibodies 101 are captured, develop color. Even when the antibodies 101 contained in the test solution reach the second color region 3, the antibodies 101 are prevented from specifically binding to the anti-mouse antibodies 104 serving as the second capture reagent. Thus, because the antibodies 101 are not captured at the second color region 3, the second color region 3 does not develop color. Consequently, a determination of a color development state of each of the first color regions 21, 22, 23 and the second color region 3 achieves an approximate determination of the concentrations of the antibodies 101 and the antigens 102.

FIG. 3 illustrates a case where the test solution includes the antibodies 101 in addition to the antigens 102 serving as the measurement object. The test solution may include complexes 106 each obtained by the antigen 102 and the antibody 101 specifically binding each other, the antigens 102 not binding to the antibodies 101 and thus separating therefrom, and the antibodies 101 not binding to the antigens 102 and thus separating therefrom. In FIG. 3, when the test solution is supplied to the carrier 10 to reach the first color regions 21, 22, and 23, the complexes 106 are basically prevented from binding to the mock antigens 103 at the first color regions 21, 22, and 23. Thus, the complexes 106, which are not captured at the first color regions 21, 22, and 23, flow towards the downstream of the carrier 10 relative to the first color regions 21, 22, and 23. The complexes 106 then specifically bind to the anti-mouse antibodies 104 contained in the second color region 3 so as to be captured thereat. As a result, depending on the concentration of the complexes 106 captured at the second color region 3, the second color region 3 develops color because of the binding of the antibodies 101 that constitute the complexes 106 to the dye.

In addition, in FIG. 3, the antigens 102 not specifically binding to the antibodies 101 (i.e., the independent antigens 102) contained in the test solution are basically prevented from binding to the mock antigens 103 at the first color regions 21, 22, and 23. Thus, the independent antigens 102 pass through the first color regions 21, 22, 23 and specifically bind to the anti-mouse antibodies 104 contained in the second color region 3 so as to be captured thereat.

Further, the antibodies 101 not binding to the antigens 102 contained in the test solution (i.e., the independent antibodies 101) basically specifically bind to the mock antigens 103 at the first color regions 21, 22, and 23 so as to be captured thereat. In this case, depending on the concentration of the antibodies 101 binding to the dye, the first color regions 21, 22, and 23 develop color.

According to the first embodiment, a comparison of intensity of color development among the first color regions 21, 22, and 23 achieves a highly accurate determination of the concentration of the measurement object (antigens 102) in the test solution. Further, the measurement of the intensity of color development of the first color regions 21, 22, 23 and the second color region 3 achieves a further highly accurate determination of the concentration of the measurement object (antigens 102) in the test solution.

According to the aforementioned first embodiment, in a practical measurement, the test solution containing the measurement object is supplied to a supply portion 11 provided at the upstream region of the carrier 10 as illustrated in FIG. 1. The test solution then generally flows in the flow direction (the direction of arrow L) along a length direction of the carrier 10 because of a capillary phenomenon, and the like. When the test solution reaches the first color regions 21, 22, and 23 at the carrier 10, the individual antibodies 101 contained in the test solution are captured by the first capture reagent in the first color regions 21, 22, and 23. As a result, the first color regions 21, 22 and 23 develop color. Further, when the test solution reaches the second color region 3 at the carrier 10, the antigens 102 constituting the complexes 106 together with the antibodies 101 are captured by the second capture reagent in the second color region 3. As a result, the second color region 3 develops color.

As mentioned above, the multiple first color regions 21, 22, and 23 that are arranged at the carrier 10 in series in the flow direction occupy the same dimensions at the carrier respectively and are specified to have the same concentrations of the first capture reagent (the mock antigens 103) per unit area. Therefore, the comparison of the intensity of the color development among the first color regions 21, 22, and 23 may contribute to an increase of the measurement accuracy for measuring the concentration of the measurement object in a case where a measurer or the like has visual contact with the test piece 1. In addition, the observation or determination of the intensity of the second color region 3 in addition to the comparison of the intensity of color development among the first color regions 21, 22, and 23 may further contribute to the increase of the measurement accuracy for measuring the concentration of the measurement object in a case where the measurer or the like has the visual contact with the test piece 1. Even in a case of the comparison of the intensity of the color development among the first color regions 21, 22, and 23 by a usage of a measuring device such as an image sensor, the measurement accuracy for the measurement of the concentration of the measurement object may increase.

In FIGS. 1 to 3, the dye binds to the antibodies 101 contained in the test solution beforehand. That is, the dye is contained in the test solution in advance. Alternatively, after an elapse of a predetermined time period after the supply of the test solution to the carrier 10, a chromogenic solution including a chromogenic substrate may be supplied to flow through the carrier 10. In this case, the chromogenic substrate flows to the downstream so as to be captured by the antibodies 101 or the antigens 102. As a result, the first color regions 21, 22, 23 and the second color region 3 develop color because of the chromogenic substrate.

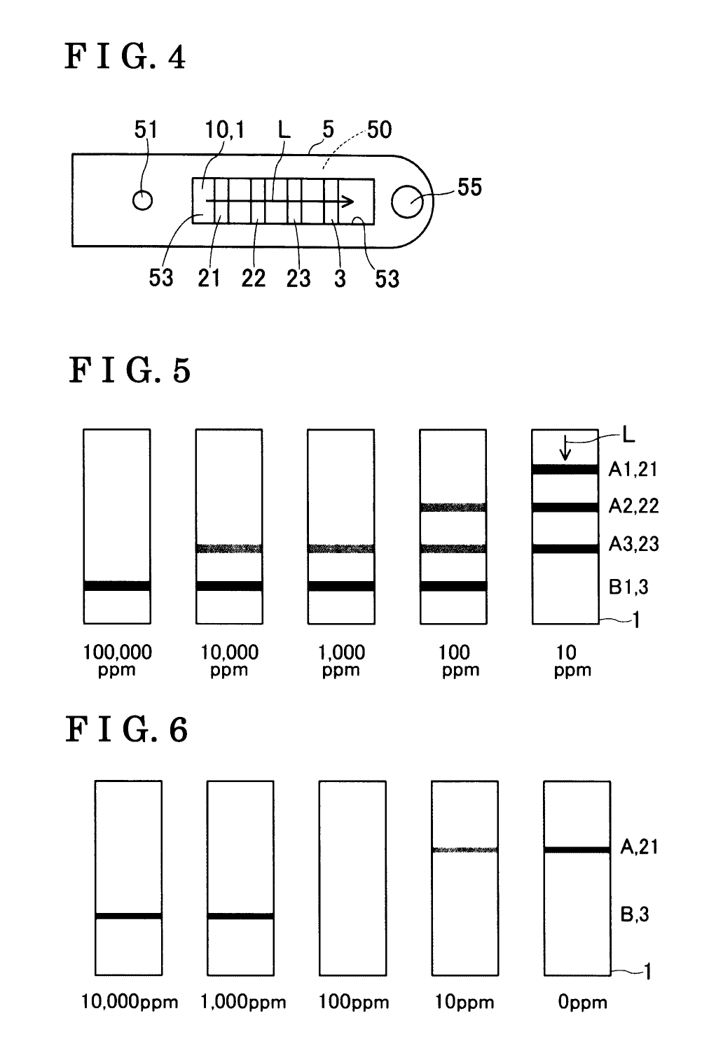

FIG. 4 is a plan view of a device serving as an immunochromatographic device that includes the test piece 1. As illustrated in FIG. 4, the carrier 10 of the test piece 1 is accommodated in an accommodating chamber 50 of a case 5 in the device. The case 5 includes a test solution supply opening 51, a window portion 53, and a display portion 55. The test solution supply opening 51 has a through hole shape and functions as the supply portion to which the test solution is dropped so that the test solution is supplied to the upstream of the carrier 10. The window portion 53 has a through hole shape so that the first color regions 21, 22, 23 and the second color region 3 are exposed. The display portion 55 displays information related to the test piece 1. The test solution supplied from the test solution supply opening 51 flows in the direction of the arrow L towards the first color regions 21, 22, 23 and the second color region 3. The case 5 is made of resin such as hard resin or metal such as stainless steel. At a time of measurement, the case 5 is generally placed or positioned on a horizontal installation surface.

(Test A)

A test A conducted on the first embodiment will be explained below. In the test A, the carrier 10 is constituted by a tape-shaped paper having a thickness of 0.05 mm to 1.0 mm, a width of 1 mm to 5 mm, and a length of 10 mm to 80 mm. In a normal temperature range, a flow speed of the test solution in the carrier 10 is specified within a range from 65 sec to 75 sec per 4 cm of the carrier 10 (the test piece 1) in the flow direction.

In the test A, the first color regions 21, 22, and 23 are arranged at the carrier 10 in series in the flow direction (the direction of the arrow L) and are spaced away from one another in the flow direction. Sizes, (i.e., dimensions) of the first color regions 21, 22, and 23 are the same as one another. In addition a distance between the adjacent first color regions 21 and 22, and a distance between the adjacent first color regions 22 and 23 are the same as each other. A length of each of the first color regions 21, 22 and 23 in parallel to the flow direction is 1 mm to 2 mm. A length of each of the first color regions 21, 22, and 23 in a direction perpendicular to the flow direction is 3 mm to 5 mm. A size (dimensions) of the second color region 3 is the same as those of the first color regions 21, 22, and 23. In addition, a distance between the second color region 3 and the adjacent first color region 23 is the same as the distances between the adjacent first color regions 21 and 22 and between the adjacent first color regions 22 and 23. The flow speed of the test solution at the carrier 10 per flow distance of 4 cm is defined to be 75 sec in a state where the test temperature is in the normal temperature range. In this test, the first color regions 21, 22, and 23 include the mock antigens 103 serving as the first capture reagent obtained by PCB-binding protein. The mock antigens 103 capture the unreacted antibodies 101. Further, the second color region 3 is arranged at the downstream of the carrier 10 relative to the first color region 23 in the flow direction. The second color region 3 includes the anti-mouse antibodies 104 that serve as the second capture reagent and that capture the complexes 106 including the antibodies 101 specifically binding to PCB (i.e., the antigens 102).

In the test A, a compound liquid, in which 5 microliter (μL) of an insulating liquid (including PCB which is the antigens 102 functioning as the measurement object) is mixed with 0.1 milliliter (mL) of a solution that contains the enzyme labeled unreacted antibodies 101 and the antigens 102 (as a solvent, 10% of DMSO and 90% of PBS in volume ratio), is prepared. At this time, DMSO is dimethyl sulfoxide and PBS is phosphate-buffered saline. The compound liquid is sufficiently stirred to obtain the test solution. 0.1 mL of the test solution is dropped at the supply portion 11 of the test piece 1 so that the test solution is supplied to the upstream of the carrier 10. After an elapse of a predetermined time (for example, 20 minutes) from the drop of the test solution, 75 μL of a color developing reagent including the dye (BCIP/NBT) is dropped and supplied to the supply portion 11 of the test piece 1 so that the color developing reagent can be supplied to the upstream of the carrier 10. After an elapse of a predetermined time period (for example, 15 minutes to 30 minutes) from the drop of the color developing reagent, the color developing state of the first color regions 21, 22, 23 and the second color region 3 at the carrier 10 of the test piece 1 is observed.

FIG. 5 illustrates a result of the color development state of the test piece 1. The first color regions 21, 22, and 23 correspond to lines A1, A2, and A3, respectively. In addition, the second color region 3 corresponds to a line B1. That is, the first color region 21 is in the form of the line A1, the second color region 22 is in the form of the line A2, the third color region 23 is in the form of the line A3, and the second color region 3 is in the form of the line B1. Each of the four lines A1, A2, A3, and B1 is colored at the carrier 10 depending on the concentration of the measurement object contained in the test solution. When the concentration of the measurement object (the antigens 102, PCB) contained in the test solution is low, i.e., the concentration is 10 ppm, it can be visibly observed that the first color regions 21, 22 and 23 are all colored. Specifically, the first color region 21 arranged at the most upstream of the carrier 10 is strongly colored, and the second color region 3 arranged at the most downstream of the carrier 10 is weakly colored. In this case, the concentration of the antigens 102 is low and the concentration of the antibodies 101 is high in the test solution. Therefore, the antibodies 101 contained in the test solution are captured by the mock antigens 103 in the first color regions 21, 22, and 23. The antibodies 101 are rarely captured at the second color region 3.

When the concentration of the measurement object is 100 ppm, the color development of the first color region 21 at the most upstream side can not be clearly visibly observed. The color development of the first color regions 22 and 23 is slightly visible. The color development of the second color region 3 arranged at the most downstream side is most visible among all the color regions. Further, when the concentration of the measurement object is 1,000 ppm, the color development of the first color region 21 at the most upstream side is not visible. The color development of the first color region 22 is not clearly visible, i.e., the color is weak. The color development of the first color region 23 is slightly visible and greater than the first color region 22. The color development of the second color region 3 at the most downstream side is most visible, i.e., the color of the second color region 3 is the strongest among the color regions.

In a case where the concentration of the measurement object is 10,000 ppm, the color development of the first color regions 21 and 22 is not visible but the color development of the first color region 23 is slightly visible. The color development of the second color region 3 at the most downstream side is most visible. In a case where the concentration of the measurement object is remarkably high, i.e., the concentration is 100,000 ppm, the color development of the first color regions 21, 22 and 23 is rarely visible. The color development of the second color region 3 at the most downstream side is most visible, i.e., the color of the second color region 3 is strong. In this case, because of the high concentration of the antigens 102, the complexes 106 obtained by the binding of the antigens 102 and the antibodies 101, and the independent antigens 102 are not captured by the mock antigens 103 at the first color regions 21, 22 and 23 and are captured by the anti-mouse antibodies 104 at the second color region 3.

As mentioned above, it can be visibly observed that the lines provided closer to the downstream side of the carrier 10 are colored in association with the increase of the concentration of the antigens 102 (PCB) serving as the measurement object contained in the test solution and the number of lines that are colored (colored lines) is decreasing. That is, it is observed that the lines provided closer to the upstream side of the carrier 10 are colored in association with the decrease of the concentration of the antigens 102 (PCB) serving as the measurement object contained in the test solution and the number of lines that are colored (colored lines) is increasing.

Accordingly, by previously providing an example of the color development that may occur at the test piece 1 to a user, the user may easily visibly observe and determine the concentration of the measurement object contained in the test solution based on the color development state of the first color regions 21, 22, 23, and the second color region 3 at the carrier 10 of the test piece 1, without using the measuring device such as the image sensor. As a matter of course, the concentration of the measurement object (PCB) contained in the test solution may be determined, by a usage of the image sensor, and the like, on a basis of the color development state of the first color regions 21, 22, 23 and the second color region 3 at the carrier 10 of the test piece 1. In such case, before the usage of the image sensor, and the like, the concentration of the measurement object (PCB) contained in the test solution may be approximately determined beforehand on a basis of the color development state of the first color regions 21, 22 and 23. Then, the concentration of the measurement object may be correctly measured by the measuring device such as the image sensor, which may contribute to a selection of sensitivity of the measuring device.

FIG. 6 illustrates a test result obtained by a comparison example manufactured basically in the same condition as the first embodiment. According to the comparison example, the number of lines that are colored is two. That is, the single first color region 21 in the form of a line A and the single second color region 3 in the form of a line B are provided. As seen in FIG. 6, although the intensity of the color development (i.e., color developing pattern) of the first color region 21 and the second color region 3 is different depending on the concentration of the measurement object, the determination is unclear as compared to the first embodiment, which may lead to a wrong determination.

### Second Embodiment

A second embodiment includes substantially the same structure and effect as those of the first embodiment. The second embodiment was tested under the same condition as the aforementioned test A. A test piece set serving as an immunochromatographic test piece set according to the second embodiment includes the multiple test pieces 1. The carrier 10 of each of the test pieces 1 has hydrophilicity so that the test solution including the measurement object flows from the upstream to the downstream of the carrier 10. When considering the capture of the measurement object based on a chemical reaction, a flow speed at which the test solution flows through the carrier 10 may influence a time period while the measurement object contained in the test solution is captured by the first capture reagent and the second capture reagent. Consequently, the measurement accuracy of the concentration of the measurement object may be affected by the flow speed of the test solution.

According to the test example illustrated in FIG. 5, when the flow speed of the test solution is extremely slow, the time period while the antibodies 101 contained in the test solution reacts to the first capture reagent in the first color regions 21, 22, and 23 is sufficient. In this case, even when the concentration of the measurement object contained in the test solution is high, the antibodies 101 of which the concentration is low may be sufficiently captured at all the first color regions 21, 22, and 23, which may promote the color development of all the first color regions 21, 22, and 23. In this case, because the first color regions 21, 22 and 23 arranged adjacent to each other are colored together, the determination of the intensity of the color development may be difficult for the user by the visible observation. The measurement accuracy may decrease accordingly. For example, in a case where the concentration of the measurement object contained in the test solution is 10,000 ppm, the color development state should be as illustrated in a fourth diagram from the right in FIG. 5. However, because of the extremely slow flow speed, the color development state as illustrated in a first or second diagram from the right in FIG. 5 may be obtained. Because of the extremely slow flow speed, the time period required for the measurement is elongated.

On the other hand in a case of an extremely fast flow speed of the test solution, the time period is insufficient for the antibodies 101 contained in the test solution to react with and to be captured by the first capture reagent of the first color regions 21, 22 and 23. Thus, even when the concentration of the measurement object contained in the test solution is low, the antibodies 101 of which the concentration is high is unlikely to be captured at the first color regions 21, 22, and 23 at the upstream side. All of the first color regions 21, 22 and 23 may not be colored accordingly. For example, when the concentration of the measurement object contained in the test solution is 10 ppm, the color development state should be as illustrated in the first diagram from the right in FIG. 5. However, because of the extremely fast flow speed, the color development state as illustrated in the second, third, or fourth diagram from the right in FIG. 5 may be obtained. In such case, the measurement accuracy for measuring the color development state may decrease. Therefore, depending on the measurement object, the appropriate flow speed for the test solution at the carrier 10 should be desirably selected.

As a result, according to the second embodiment, the flow speed of the test solution at the carrier 10 of one of the test pieces 1 of the test piece set is different from another of the test pieces 1. That is, the multiple test pieces 1 having the different flow speeds are prepared. The user can select one of the test pieces 1 having the most appropriate flow speed for the measurement object contained in the test solution. In this case, a pore size and/or porosity of the carrier 10 may be changed to thereby adjust the flow speed of the test solution at the carrier 10. Specifically, the porosity is relatively increased and the pore size is also relatively increased so as to increase the flow speed.

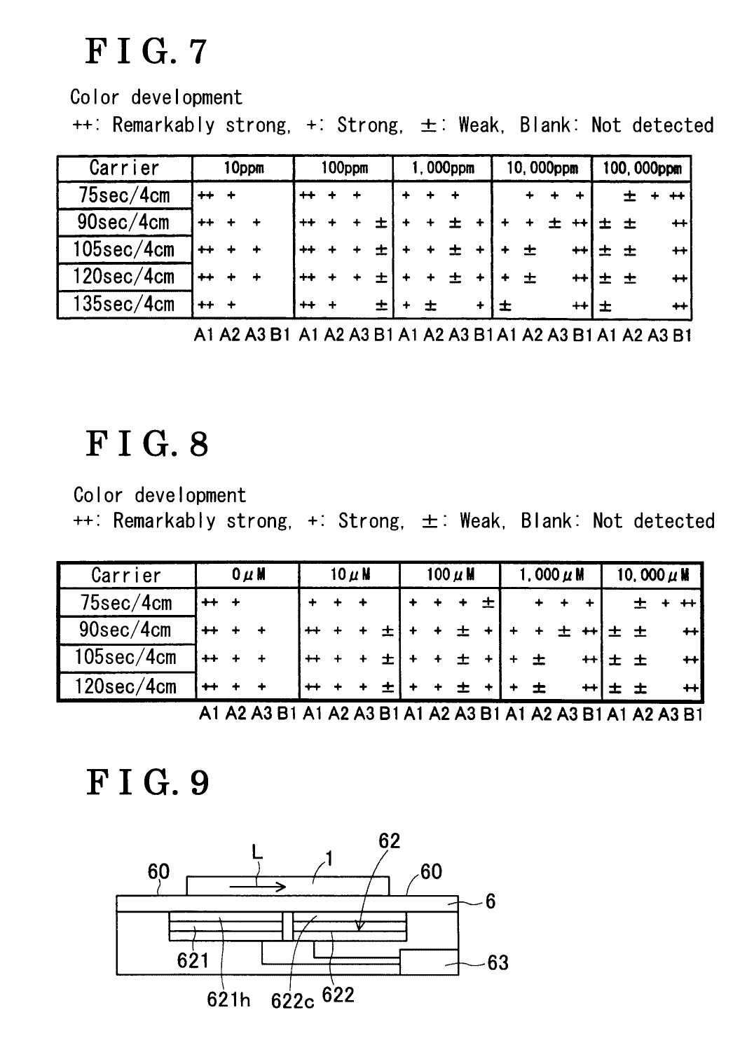

Specifically, as illustrated in FIG. 7, the multiple test pieces 1 are prepared beforehand, in which the flow speed of a developing solution (test solution) per flow distance of approximately 4 cm is specified to be 75 sec, 90 sec, 105 sec, 120 sec, and 135 sec in a state where the environmental temperature falls within the normal temperature range, i.e., in a state of the same environmental temperature.

FIG. 7 illustrates a relationship among the concentration of the antigens (PCB) serving as the measurement object contained in the test solution, the flow speed of the test solution, and the color development state of the lines A1, A2, A3, and B1 in a case where a test was conducted basically in the same condition as the aforementioned test A on the multiple test pieces 1 having the different flow speeds. The concentration of the antigens (PCB) changes among 10 ppm, 100 ppm, 1,000 ppm, 10,000 ppm, and 100,000 ppm. In FIG. 7, “++” indicates a state where the remarkably strong color development is visibly detected. “+” indicates a state where the strong color development is visibly detected. “±” indicates a state where the weak color development is visibly detected. A blank indicates a state where no color development is visibly detected. As seen in FIG. 7, patterns of the intensity of the color development of the first color regions 21, 22, and 23 are the same even when the flow speed at the carrier 10 changes. However, in a case of the carrier 10 having the high flow speed, the color development of the first color region 21 tends to be weak. The intensity of the color development of the first color regions 21, 22, and 23 is clear so that the determination accuracy of the concentration of the measurement object may increase. As for the flow speed, alternatively, the multiple test pieces 1 in which the flow speed per flow distance of 4 cm is specified to be 50 sec, 60 sec, 70 sec, 80 sec, 90 sec, and 100 sec may be prepared.

### Third Embodiment

According to a third embodiment, an individual producing capacity of equol that is one of female hormones is measured as the measurement object contained in the test solution. In this case, the concentration of equol corresponds to a urine concentration. The urine is diluted 1:1000 in volume in phosphate buffered saline so as to obtain the test solution. In this case, the determination is necessary in a wide range of concentrations. Thus, based on 40 μM that is a criterion for the producing capacity, the measurement was conducted with the concentration of 0 μM, 10 μM, 100 μM, 1,000 μM, and 10,000 μM. FIG. 8 illustrates a test result. In a practical test, the test solution (i.e., the aforementioned urine) was further diluted 1:10. The test was conducted basically in the same test condition as that of the test A mentioned above. As seen in FIG. 8, in a case of the carrier 10 having the fast flow speed, the color development of the first color region 21 tends to be weak and the intensity of the color development state of the first color regions 21, 22 and 23 is clear, which leads to the high determination accuracy of the concentration of the measurement object.

### Fourth Embodiment

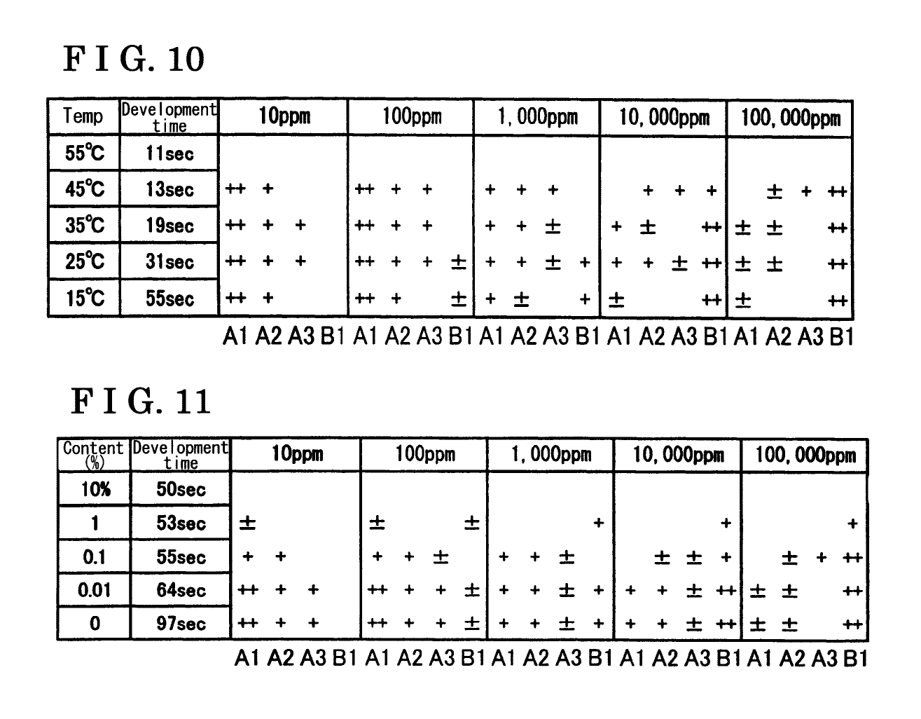

A fourth embodiment will be explained with reference to FIGS. 9 and 10. The fourth embodiment includes basically the same structure and effect as that of the first embodiment. As illustrated in FIG. 9, a system serving as an immunochromatographic system according to the fourth embodiment includes a holding portion 6 having a flat-shaped holding surface 60 and holding the test piece 1, a temperature adjusting portion 62, and a controller 63. The holding surface 60 is formed by a heat-transfer material having a heat-transfer ability. The temperature adjusting portion 62 adjusts a temperature of the test piece 1 held by the holding surface 60 of the holding portion 6. The controller 63 adjusts a temperature of the temperature adjusting portion 62. The temperature adjusting portion 62 includes a first temperature adjusting portion 621 for heating and a second temperature adjusting portion 622 for cooling. The first temperature adjusting portion 621, which is formed by a Peltier element, includes a heating portion 621h arranged so as to face a rear surface of the holding portion 6. The second temperature adjusting portion 622, which is also formed by a Peltier element, includes a cooling portion 622c arranged so as to face the rear surface of the holding portion 6. A metal formed by a copper alloy, an aluminum alloy, an alloy steel and the like, or conductive ceramics such as an aluminum nitride and a silicon carbide may serve as the heat-transfer material.

Upon measurement of the concentration of the measurement objet, the user places and holds the test piece 1 on the holding surface 60 of the holding portion 6. In this state, the test piece 1 is heated so that the temperature thereof falls within an appropriate temperature range. The appropriate temperature range is defined to be from 5° C. to 70° C., a range from 10° C. to 55° C., or the like, which depends on the test solution, the material of the carrier 10, and the like. Because the measurement object is measured under the aforementioned state, the temperature of the carrier 10 is stabilized even when a measurement environment has an extremely low temperature (i.e., 0° C.) or an extremely high temperature. Thus, the flow speed of the test solution at the carrier 10 is stabilized so as to highly accurately measure the concentration of the measurement object contained in the test solution.

FIG. 10 illustrates a relationship among the test temperature, the concentration of the antigens (PCB) as the measurement object, the flow speed of the test solution, and the color development state of the lines A1, A2, A3, and B1 in a state where a test basically similar to the aforementioned test A was conducted on each of the test pieces 1 according to the fourth embodiment. The test was conducted substantially in the same condition as that of the test A. A development time in FIG. 10 corresponds to the flow speed of the test solution and corresponds to a time period while the test solution flows in the flow direction at the window portion 53 of the case 5. As seen in FIG. 10, in association with the increase of the temperature of the holding surface 60, the development time of the test solution is decreasing (i.e., the flow speed is increasing). As a result, in the case of the decreased development time, the color development state (the intensity of the color development) of the first color regions 21, 22, 23 and the second color region 3 is clearly observed to thereby improve the determination accuracy of the concentration of the measurement object.

In the test illustrated in FIG. 10, the flow speed of the test solution at the carrier 10 is appropriately adjusted or controlled when the temperature is in a range from 15° C. to 45° C. The color development state of the first color regions 21, 22, and 23 is clearly visible accordingly. On the other hand, when the temperature is 55° C., the flow speed of the test solution at the carrier 10 is too fast, which prevents the color development from being sufficiently or clearly visible. However, the adjustment of the porosity and/or the porous size of the carrier 10 may control the flow speed of the test solution. Therefore, even when the temperature is 55° C., the intensity of the color development may be clearly visible, which leads to the improvement of the determination accuracy.

### Fifth Embodiment

A fifth embodiment will be explained with reference to FIG. 11. The fifth embodiment includes substantially the same structure and effect as those of the first embodiment. According to the fifth embodiment, because a hydrophilic surfactant (Triton X-100 manufactured by Wako Pure Chemical Industries, Ltd.) is included in the test solution, the flow speed of the test solution increases. FIG. 11 illustrates a relationship among a content percentage of the hydrophilic surfactant in volume in the test solution, the concentration of the antigens (PCB) as the measurement object, the development time, and the color development state of the lines A1, A2, A3, and 81 in a state where a test substantially the same as the test A was conducted on each of the test pieces 1 according to the fifth embodiment. The fifth embodiment was tested substantially under the same condition as that of the test A.

As seen in FIG. 11, when the hydrophilic surfactant is included in the carrier 10, the development speed of the test solution is influenced to thereby increase the flow speed. When the concentration of the hydrophilic surfactant is 10%, the color development of the first color regions 21, 22 and 23 is not visibly observed. At this time, by the adjustment of the porosity and/or the porous size of the carrier 10, the flow speed of the test solution may be controlled and adjusted appropriately. Therefore, even when the concentration of the hydrophilic surfactant is 10%, the color development state of the first color regions 21, 22, 23 and the second color region 3 is visibly observed. As a result, the concentration of the hydrophilic surfactant contained in the test solution and supplied to the carrier 10 is generally specified within a range from 0.01% to 10%, specifically, within a range from 0.1% to 5%, though the concentration depends on materials of the carrier 10 and types of the hydrophilic surfactant.

### Sixth Embodiment

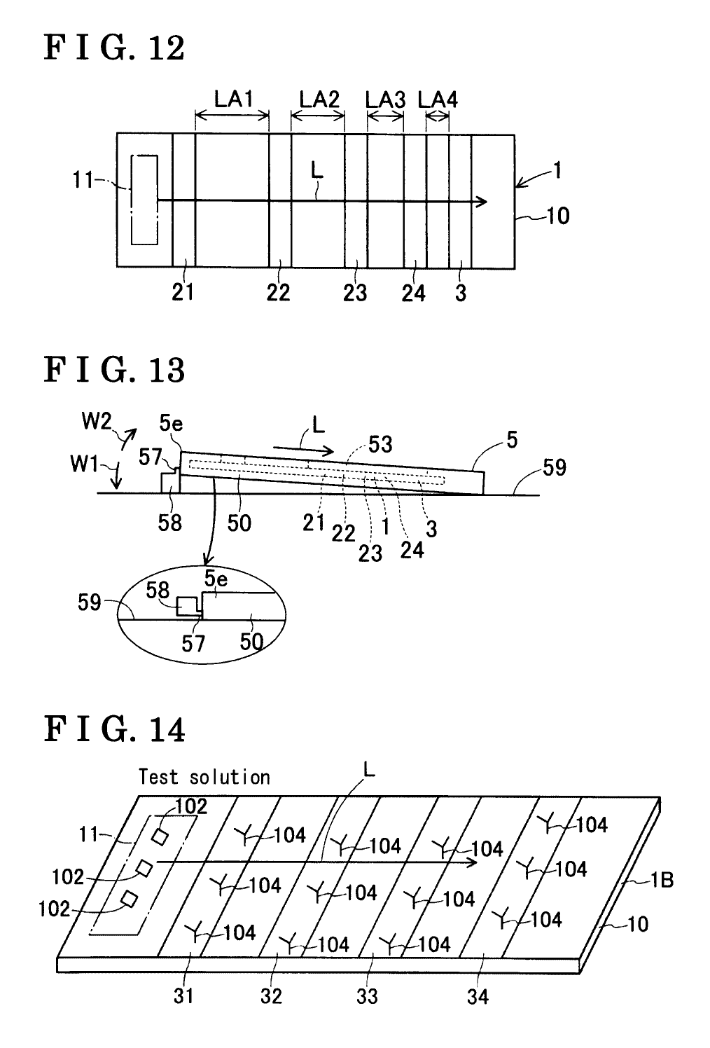

A sixth embodiment will be explained with reference to FIG. 12. The sixth embodiment includes basically the same structure and effect as those of the aforementioned first to fifth embodiments. In the sixth embodiment, a total of four first color regions 21, 22, 23, and 24 are provided. The flow speed of the test solution is generally fast at the upstream and is gradually decreasing towards the downstream in the flow direction (the direction of the arrow L) of the carrier 10. Therefore, according to the sixth embodiment, distances among the first color regions 21, 22, 23, 24 and the second color region 3, i.e., pitches LA1, LA2, LA3, and L4 are specified in such a manner that the distance (pitches) is gradually decreasing towards the downstream in the flow direction of the carrier 10. In FIG. 12, the pitch LA1 is the longest while the pitch LA4 is the shortest among the pitches LA1, LA2, LA3, and LA4. Accordingly, even when the flow speed is slow, a time period while the test solution reaches the second color region 3 is shortened, which contributes to the reduction of the measurement time. At this time, the pitches LA1, LA2, LA3, and LA4 are specified to be appropriate values so that the possible color development of the first color regions 21, 22 and 23 is easily observed.

### Seventh Embodiment

A seventh embodiment will be explained with reference to FIG. 13. The seventh embodiment includes basically the same structure and effect as those of the first to sixth embodiments. The case 5 of the device includes the accommodating chamber 50 that accommodates the test piece 1 and the window portion 53 through which the first color regions 21, 22, 23 and the second color region 3 of the test piece 1 are exposed externally and upwardly. The case 5 includes an inclination forming portion 58. Because of the inclination forming portion 58, the test piece 1 accommodated within the accommodating chamber 50 is inclined downwardly from the upstream to the downstream in the flow direction of the carrier 10. The inclination forming portion 58 is connected via a self hinge portion 57 to an end portion 5e at the upstream side of the case 5 so as to be rotatable in directions of arrows W1 and W2 in FIG. 13. In a case where the flow speed of the test solution is extremely slow, the case 5 is placed on an installation surface 59 in a state where the inclination forming portion 58 is rotated in the direction of the arrow W1 via the self hinge portion 57, thereby lifting up the end portion 5e of the case 5 at the upstream side. Therefore, the test piece 1 accommodated within the case 5 is inclined downwardly from the upstream to the downstream, thereby assisting the increase of the flow speed of the test solution. In a case where the flow speed of the test solution is appropriate, the inclination forming portion 58 is not used, i.e., the inclination forming portion 58 is rotated in the direction of the arrow W2 via the self hinge portion 57 so that the case 5 is placed horizontally on the installation surface 59. The inclination forming portion 58 may be separately provided from the case 5.

### Eighth Embodiment

An eighth embodiment will be explained with reference to FIG. 14. The eighth embodiment includes basically the same structure and effect as those of the first to seventh embodiments. A test piece 1B serving as the immunochromatographic test piece is provided to measure the concentration of the measurement object contained in the test solution. The test piece 1B includes the carrier 10 formed by paper, and the like having hydrophilicity so that the test solution including the measurement object flows from the upstream to the downstream. The test piece 18 also includes multiple color regions 31, 32, 33 and 34 serving as the second color region arranged at the carrier 10 in series in the flow direction and spaced away from one another in the flow direction. The color regions 31, 32, 33, and 34 include the anti-mouse antibodies 104 serving as the capture reagent capturing the antigens 102 such as PCB. The color regions 31, 32, 33, and 34 arranged in series in the flow direction are formed at respective portions of the carrier 10, the respective portions having the same dimensions and including the same concentrations of the anti-mouse antibodies 104 per unit area.

Specifically, the highest concentration of the antibodies 104 per unit area among the color regions 31, 32, 33 and 34 is defined to be Dmax while the lowest concentration of the antibodies 104 per unit area among the color regions 31, 32, 33 and 34 is defined to be Dmin. A value of Dmax/Dmin may fall within a range from 0.85 to 1.15, a range from 0.90 to 1.10, or a range from 0.95 to 1.05. Specifically, the value of Dmax/Dmin may fall within a range from 0.98 to 1.02 or may be equal to 1.0. A reagent solution including the anti-mouse antibodies 104 as the capture reagent having the same concentrations is applied to the carrier 10, or the carrier 10 is immersed with the reagent solution so that the first color regions 31, 32, 33, and 34 are arranged at the single carrier 10 in series in the flow direction. The aforementioned concentration of the antibodies 104 corresponds to a volume of carrier of the capture reagent. The distances among the color regions 31, 32, 33, and 34 may be the same or be increasing towards the downstream in the flow direction of the carrier 10.

When the test solution is dropped and supplied to the supply portion 11 of the carrier 10, the test solution flows towards the downstream of the carrier 10 by the capillary phenomenon, and the like. When the test solution reaches the color region 31, the antigens 102 contained in the test solution specifically bind to the antibodies 104 of the color region 31. Then, in a post-processing, a fluid including the dye is supplied to the carrier 10 to flow towards the downstream, thereby causing the dye to bind to the antigens 102. Depending on the concentration of the antigens 102 captured at the color region 31, the color region 31 is colored.

Further, when the test solution reaches the color region 32, the antigens 102 contained in the test solution specifically bind to the antibodies 104 in the color region 32, thereby causing the color region 32 to be colored. Such incident occurs in the same manner at the color regions 33 and 34.

In a case where the concentration of the antigens 102 contained in the test solution is low, the specific binding of the antigens 102 to the antibodies 104 tends to occur at the color region 31 arranged at the upstream side of the carrier 10, in the same way as illustrated in FIG. 5. As a result, the color development of the color region 31 at the upstream side becomes stronger while the color development of the color region 34 at the downstream side becomes weaker or disappears. In addition, in a case where the concentration of the antigens 102 contained in the test solution is extremely high, the antigens 102 not only bind to the antibodies 104 contained in the color regions 31, 32, and 33 but also bind to the antibodies 104 contained in the color region 34 at the downstream side. The color development of the color region 34 at the downstream side becomes stronger. Accordingly, depending on the concentration of the antigens 102 contained in the test solution, the different intensity of the color regions 31, 32, 33 and 34 is obtained.

Accordingly, by previously providing an example of the color development that may occur at the test piece 1B to a user, the user may easily visibly observe and determine the concentration of the measurement object contained in the test solution based on the color development state of the color regions 31, 32, 33, and 34 at the carrier 10 of the test piece 1B, without using an image sensor and the like. As a matter of course, the concentration of the measurement object contained in the test solution may be determined, by a usage of the image sensor, and the like, on a basis of the color development state of the color regions 31, 32, 33 and 34 at the carrier 10 of the test piece 1B. In such case, before the usage of the image sensor, and the like, the concentration of the measurement object contained in the test solution may be approximately determined beforehand on a basis of the color development state of the color regions 31, 32, 33 and 34. Then, the concentration of the measurement object may be correctly measured by the measuring device such as the image sensor, which may contribute to a selection of sensitivity of the measuring device.

According to the aforementioned first embodiment, the number of first color regions is three, i.e., the first color regions 21, 22, and 23, and the number of second color regions is one, i.e., the second color region 3. Alternatively, the number of first color regions may be four, five, six, or more while the number of second color regions may be two or more. In addition, according to the aforementioned seventh embodiment, the device includes the test piece 1, the case 5 having the accommodating chamber 50 accommodating the test piece 1 and the window portion 53 at which the color regions are exposed externally, and the inclination forming portion 58 causing the test piece 1 accommodated within the case 5 to incline downwardly from the upstream to the downstream in the flow direction. The inclination forming portion 58 may be integrally formed or separately formed relative to the case 5.

The measurement object contained in the test solution may be labeled with a labeling substance so as to be detected. At this time, a portion of the carrier 10 where the test solution is supplied may be labeled with a labeling substance so that the labeling substance binds to the measurement object contained in the test solution that is supplied to the carrier 10. Further, after the test solution is supplied to the carrier 10 of the test piece 1, 1B, a solution containing a labeling substance such as a substance labeled with a die may be supplied to the carrier 10 in the post-processing. In this case, the labeling substance supplied to the carrier 10 in the post-processing may bind to the measurement object captured at the color region or adhere to a vicinity of the measurement object. As the labeling substance, a dye such as a dye particle, a fluorescence particle, a carbon particle, and a gold particle, an enzyme, or the like is applied.

According to the aforementioned first to eighth embodiments, the multiple color regions 21, 22, 23, and 3 (21, 22, 23, 24, and 3) (31, 32, 33, and 34) are formed at respective portions of the carrier 10, the respective portions having the same dimensions and including the same concentrations of the first capture reagent (the mock antigens 103) per unit area. Therefore, even when a user or the like visibly observes the test piece 1, 1B, the comparison of the intensity of the color development among the color regions 21, 22, 23, and 3 (21, 22, 23, 24, and 3) (31, 32, 33, and 34) that are arranged at the carrier 10 in series in the flow direction may achieve the improved measurement accuracy for measuring the concentration of the measurement object. In a case where the intensity of the color development among the color regions 21, 22, 23, and 3 (21, 22, 23, 24, and 3) (31, 32, 33, and 34) is compared by means of an image sensor, or the like, the measurement accuracy may be also enhanced. If the multiple color regions 21, 22, 23, and 3 (21, 22, 23, 24, and 3) (31, 32, 33, and 34) are configured to have the different concentrations of the capture reagent (the mock antigens 103) per unit area, the sufficient measurement accuracy may not be obtained by the comparison of the intensity of the color development among the multiple color regions 21, 22, 23, and 3 (21, 22, 23, 24, and 3) (31, 32, 33, and 34) by the visual observation, the image sensor, or the like.

The antibodies and/or the antigens are used as the measurement object contained in the test solution, for example. The antigens that specifically bind to the antibodies serving as the measurement object or secondary antibodies are used as the capture reagent contained in the color regions 21, 22, 23, and 3 (21, 22, 23, 24, and 3) (31, 32, 33, and 34) at the carrier 10, for example. Alternatively, the antibodies that specifically bind to the antigens serving as the measurement object are used as the capture reagent contained in the color regions 21, 22, 23, and 3 (21, 22, 23, 24, and 3) (31, 32, 33, and 34), for example. The capture reagent dissolved or dispersed in a solution represented by a buffer solution such as a phosphate buffered saline is applied to the carrier 10 or the carrier 10 is immersed with such solution so as to obtain the color regions 21, 22, 23, and 3 (21, 22, 23, 24, and 3) (31, 32, 33, and 34).

According to the aforementioned first to seventh embodiments, the multiple first color regions 21, 22, and 23 (21, 22, 23 and 24) are formed at respective portions of the carrier 10, the respective portions having the same dimensions and including the same concentrations of the first capture reagent (the mock antigens 103) per unit area. Therefore, even when a user or the like visibly observes the test piece 1, the comparison of the intensity of the color development among the first color regions 21, 22, and 23 (21, 22, 23 and 24) that are arranged at the carrier 10 in series in the flow direction may achieve the improved measurement accuracy for measuring the concentration of the measurement object. Further, the comparison of the intensity of the color development among the first color regions 21, 22, and 23 (21, 22, 23 and 24) and the second color region 3 may further achieve the improved measurement accuracy for measuring the concentration of the measurement object. In a case where the intensity of the color development among the first color regions 21, 22, and 23 (21, 22, 23 and 24) is compared by means of an image sensor, or the like, the measurement accuracy may be also enhanced. If the multiple first color regions 21, 22, and 23 (2′1, 22, 23 and 24) are configured to have the different concentrations of the first capture reagent (the mock antigens 103) per unit area, a sufficient measurement accuracy may not be obtained by the comparison of the intensity of the color development among the multiple color regions 21, 22, and 23 (21, 22, 23 and 24) by the visual observation, the image sensor, or the like.

The antibodies are used as the measurement object contained in the solution, for example. In this case, the antigens that specifically bind to the antibodies serving as the measurement object or secondary antigens are used as the first capture reagent contained in the first color regions 21, 22, and 23 (21, 22, 23 and 24) at the carrier 10. Then, the antibodies are used as the second capture reagent contained in the second color region 3, for example.

Further, the antigens are used as the measurement object contained in the test solution, for example. In this case, the antibodies that specifically bind to the antigens serving as the measurement object are used as the first capture reagent contained in the first color regions 21, 22, and 23 (21, 22, 23 and 24), for example. Then, the antibodies that specifically bind to the antigens serving as the measurement object are used as the second capture reagent contained in the second color region 3, for example.

The first capture reagent dissolved or dispersed in a solution represented by a buffer solution such as a phosphate buffered saline is applied to the carrier 10 or the carrier 10 is immersed with such solution so as to obtain the first color region 21, 22, and 23 (21, 22, 23 and 24), for example. In the same manner, the second capture reagent dissolved or dispersed in a solution represented by a buffer solution such as a phosphate buffered saline is applied to the carrier 10 or the carrier 10 is immersed with such solution so as to obtain the second color region 3, for example.

According to the aforementioned second to fifth embodiments, the carrier 10 of each of the multiple test pieces 1 causes the test solution that includes the measurement object to flow from the upstream to the downstream of the carrier 10 in the flow direction. The flow speed of the test solution at the carrier 10 of one of the test pieces 1 is different from the flow speed of the test solution at the carrier 10 of the other of the test pieces 1.

Because the capture of the measurement object contained in the test solution by the capture reagent is a chemical reaction, a time scale may be desirably considered. The flow speed of the test solution at the carrier 10 of the test piece 1 influences the reaction in which the measurement object contained in the test solution is captured by the capture reagent. That is, depending on the flow speed, the measurement object contained in the test solution may be captured or not captured by the capture reagent. In this case, if the concentration of the measurement object is not compatible with the flow speed at the test piece 1, the color development of the test piece 1 and further the measurement accuracy may be affected.

Therefore, according to the second to fifth embodiments, the different flow speeds of the test solution flowing through the carrier 10 are specified for the multiple test pieces 1. One of the appropriate test pieces 1 is selectable depending on the type of the measurement object, the estimated concentration, and the like. As a result, the measurement object is captured by the capture reagent depending on the type of the measurement object, the estimated concentration, and the like. The flow speed of the test solution flowing through the carrier 10 is adjustable on a basis of the pore size and/or porosity of the carrier 10.

According to the aforementioned fourth embodiment, the system includes the test piece 1, the holding portion 6 including the holding surface 60 that holds the test piece 1, and the temperature adjusting portion 62 adjusting a temperature of the test piece 1 held by the holding surface 60 of the holding portion 6.

Depending on the type of the measurement object and the like, the measurement temperature at the carrier 10 of the test piece 1 may influence the reaction in which the measurement object contained in the test solution is captured by the capture reagent. Thus, because of the temperature, the measurement object contained in the test solution may be captured or may not be captured by the capture reagent. Specifically, in a low temperature environment, the flow speed of the test solution decreases remarkably, thereby excessively increasing the measurement time. Therefore, according to the fourth embodiment, the temperature of the test piece 1 held by the holding surface 60 of the holding portion 6 is adjusted by the temperature adjusting portion 62 to an appropriate temperature range so that the temperature of the carrier 10 of the test piece 1 is stabilized. As a result, the measurement accuracy is enhanced and the measurement time in the low temperature environment may be reduced.

According to the aforementioned seventh embodiment, the device includes the test piece 1, and the case 5 including the accommodating chamber 50 accommodating the test piece 1 and the window portion 53 at which the color regions 21, 22, 23, and 3 of the test piece 1 are exposed externally, and the inclination forming portion 58 causing the test piece 1 accommodated within the case 5 to incline downwardly from the upstream to the downstream of the carrier 10 in the flow direction.

Because of the inclination forming portion 58, the test piece 1 accommodated within the case 5 is inclined downwardly from the upstream to the downstream in the flow direction. In this case, a gravity force in addition to the capillarity phenomenon, and the like may act on the flow of the test solution. Thus, the flow speed of the test solution flowing through the carrier 10 of the test piece 1 is adjustable depending on an inclination angle of the test piece 1 obtained on a basis of the inclination forming portion 58.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An immunochromatographic test piece measuring a concentration of a measurement object included in a solution, comprising:
a carrier causing the solution that includes the measurement object to flow from an upstream to a downstream of the carrier; and
a plurality of color regions arranged at the carrier in series in a flow direction in which the solution flows through the carrier and spaced away from one another in the flow direction, the plurality of color regions each including a capture reagent and being colored while capturing the measurement object included in the solution by the capture reagent, the plurality of color regions being formed at respective portions of the carrier, the respective portions having same dimensions and including same concentrations of the capture reagent per unit area.

2. An immunochromatographic test piece measuring a concentration of a measurement object included in a solution, comprising:
a carrier causing the solution that includes the measurement object to flow from an upstream to a downstream of the carrier;
a plurality of first color regions arranged at the carrier in series in a flow direction in which the solution flows through the carrier and spaced away from one another in the flow direction, the plurality of first color regions each including a first capture reagent and being colored while capturing the measurement object included in the solution by the first capture reagent; and
a second color region arranged at the downstream of the carrier in the flow direction relative to the plurality of first color regions and including a second capture reagent capturing the measurement object included in the solution that has passed through the plurality of first color regions, the second color region being colored while capturing the measurement object by the second capture reagent,
the plurality of first color regions being formed at respective portions of the carrier, the respective portions having same dimensions and including same concentrations of the first capture reagent per unit area.

3. An immunochromatographic test piece set including a plurality of the immunochromatographic test pieces according to claim 1, wherein the carrier of each of the plurality of the immunochromatographic test pieces causes the solution that includes the measurement object to flow from the upstream to the downstream of the carrier in the flow direction, a flow speed of the solution at the carrier of one of the immunochromatographic test pieces being different from a flow speed of the solution at the carrier of the other of the immunochromatographic test pieces.

4. An immunochromatographic test piece set including a plurality of the immunochromatographic test pieces according to claim 2, wherein the carrier of each of the plurality of the immunochromatographic test pieces causes the solution that includes the measurement object to flow from the upstream to the downstream of the carrier in the flow direction, a flow speed of the solution at the carrier of one of the immunochromatographic test pieces being different from a flow speed of the solution at the carrier of the other of the immunochromatographic test pieces.

5. An immunochromatographic system comprising:
an immunochromatographic test piece according to claim 1;
a holding portion including a holding surface that holds the immunochromatographic test piece; and
a temperature adjusting portion adjusting a temperature of the immunochromatographic test piece held by the holding surface of the holding portion.

6. An immunochromatographic system comprising;
an immunochromatographic test piece according to claim 2;
a holding portion including a holding surface that holds the immunochromatographic test piece; and
a temperature adjusting portion adjusting a temperature of the immunochromatographic test piece held by the holding surface of the holding portion.

7. An immunochromatographic device comprising:
an immunochromatographic test piece according to claim 1;
a case including an accommodating chamber accommodating the immunochromatographic test piece and a window portion at which the color regions of the immunochromatographic test piece are exposed externally; and
an inclination forming portion causing the immunochromatographic test piece accommodated within the case to incline downwardly from the upstream to the downstream of the carrier in the flow direction.

8. An immunochromatographic device comprising:
an immunochromatographic test piece according to claim 2;
a case including an accommodating chamber accommodating the immunochromatographic test piece and a window portion at which the first and second color regions of the immunochromatographic test piece are exposed externally; and
an inclination forming portion causing the immunochromatographic test piece accommodated within the case to incline downwardly from the upstream to the downstream of the carrier in the flow direction.
